(19) United States
(12) Patent Application Publication
(10) Pub. No.: US 2015/0040000 A1
(43) Pub. Date: Feb. 5, 2015

(54) METHODS AND SYSTEMS FOR GENERATING SERVER-SIDE MEDIA QUERIES

(71) Applicant: Moboom Ltd., Subiaco (AU)

(72) Inventors: Jeffrey David Rice, Belvedere Tiburon, CA (US); Benjamin Peter Sargent, Calgary, Alberta (CA)

(21) Appl. No.: 14/338,134

(22) Filed: Jul. 22, 2014

Related U.S. Application Data
(60) Provisional application No. 61/861,807, filed on Aug. 2, 2013.

(51) Int. Cl. G06F 17/22

(52) U.S. Cl. CPC G06F 17/2247
USPC 715/235

(57) ABSTRACT

Systems and methods are configured to generate server-side media queries and customized cascading style sheets. A server receives a request for content and a user agent from a device browser. The server serves device cookie generation code to the device, wherein the device cookie generation code is configured to be executed by the device browser to obtain properties of the device from the requesting device and to store the obtained properties as a device cookie. The server receives the device cookie from the requesting device. The server accesses a device description database and utilizes information from the user agent to locate corresponding device properties from the device description database. The server compiles a cascading style sheet based on properties stored in the device cookie and the located corresponding device properties from the device description database. The cascading style sheet is served to the requesting device.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference in their entirety under 37 CFR 1.57.

### BACKGROUND OF THE INVENTION

1. Field of the Invention

The present invention is generally related to generating Cascading Stylesheets.

2. Description of the Related Art

Cascading Stylesheets (CSSs) are used to describe the appearance and formatting of a document, such as a webpage, written using a markup language. The CSS specification describes a syntax known as a Media Query (MQ). MQs are used to conditionally apply CSS properties to a document based on the physical capabilities or characteristics of the browser.

A Media Query specifies a media type and one or more media feature expressions. The result of a given query is true if the media type specified in the Media Query matches the type of device or browser the document is being displayed on and if all expressions in the Media Query are true. When a Media Query is true, the corresponding style sheet or style rules are applied, following the cascading rules. Disadvantageously, the browser may download CSS rules which are not supported by the browser (e.g., the browser will ignore the CSS rules and not execute them), thus unnecessarily increasing the total CSS file size being downloaded. Further, conventionally a Stylesheet author is limited to the Media Queries supported by the browser manufacturer, if any.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. It is understood that while various aspects are described, certain embodiments may include any combination of the described aspects, or subsets thereof.

Example systems and methods described herein optionally add support for Media Query properties to unsupported applications, such as web browsers that do not support such Media Query properties. Further, the example systems and methods described herein optionally reduce the size of files, such as CSS files, being downloaded to a user device, such as a mobile phone or other browser-equipped device, by excluding CSS directives that would not be understood and/or executed by the browser of the client device.

By way of example, optionally, when a user device browser accesses a first system (e.g., a web server), the first system provides a program to the user device browser. The user device browser executes the program. The executed program may identify one or more characteristics of the user device (e.g., the precise user device model number/version, physical characteristics of the user device (e.g., the user device display resolution, the user device orientation, etc.)), and optionally stores at least a portion of characteristics information on the user device as a device cookie. The first system may then access the user device cookie and utilize device information included in the device cookie to customize a document, such as a webpage CSS file, so as to be appropriate for the device's characteristics. For example, various models of a given phone may have different sizes in terms of pixels.

By way of illustration, an old model of a given phone may have a 320×480 pixel display, a relatively newer model of the given phone may have a 640×960 pixel display, and the newest model of the given phone may have a 640×1136 pixel display. However, conventionally, each model phone may simply identify the device browser via a user agent, but not the screen size or pixel count. Optionally, the program may query the phone to determine the precise model and/or display size and locally store the corresponding device information in a device cookie. In this example, when the user device requests a webpage, the first system may retrieve the device cookie from the user device, determine the user device display size, and configure the webpage to be the appropriate size for the user device, rather than providing an inappropriately large layout for the display size (e.g., providing a layout configured for a desktop display to a phone having a much smaller display, requiring the user to horizontally scroll to view the entire webpage) or too small a webpage (e.g., providing a layout configured for a phone to a table having a significantly larger display) for rendering.

By way of further example, the first system optionally identifies a specific model of a user device using a device cookie and/or a user agent, and uses the identification of the specific model to access physical and/or functional characteristics of the user device from a database of devices that includes information on the physical and/or functional characteristics of devices. By way of example, the database of devices may optionally indicate a particular device model's display resolution, display orientation, level of CSS supported (and the degree of support for a given CSS level), etc.

An example aspect of the disclosure comprises a computer implemented method of customizing a cascading style sheet for a requesting device, the method comprising: receiving at a server a first request for content from a browser of a requesting device, wherein the requesting device does not support or is not configured to execute at least one media query property; receiving at the server a user agent from the requesting device, the user agent comprising text identifying the browser type; serving the first requested content and device cookie generation code to the requesting device, wherein the device cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent; receiving at the server the device cookie from the requesting device; accessing by the server a device description database, the device description database comprising device properties for a plurality of browser-equipped devices; utilizing information from the user agent from the requesting device to locate corresponding device properties from the device description database; compiling, by the server using a server side media query compiler, a cascading style sheet based at least in part on properties stored in the device cookie, including at least the display size, and the located corresponding device properties from the device description database, wherein the compiler is configured to exclude, based on the properties stored in the device cookie and the located corresponding device properties, one or more browser CSS properties that are not supported or that will not be executed by the browser of the requesting device; and serving by the first system the cascading style sheet to the requesting device. Optionally, the requesting device is a feature phone and the server side media query compiler is configured to exclude or delete from the cascading style sheet directives not executable by the feature phone browser. In certain instances the requesting device does not support CSS level 3, and the server side media query compiler is optionally configured to exclude or delete from the cascading style sheet CSS level 3 directives not executable by the requesting device. Optionally, the device cookie generation code is included at a beginning of the first requested content. In certain instances, the requesting device does not support media queries. The device cookie optionally identifies one or more device properties not provided by the user agent or the device description database.

An example aspect of the disclosure comprises a computer implemented method of customizing a cascading style sheet for a requesting device, the method comprising: receiving at a first system a first request for content from a browser of a requesting device, the first system comprising hardware; receiving at the first system a user agent from the requesting device, the user agent comprising text identifying the browser type; serving cookie generation code to the requesting device, wherein the cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent; receiving at the first system the device cookie from the requesting device; accessing by the first system a device description database, the device description database comprising device properties for a plurality of browser-equipped devices; utilizing information from the user agent from the requesting device to locate corresponding device properties from the device description database; compiling, by the first system a cascading style sheet based at least in part on properties stored in the device cookie, including at least the display size, and the located corresponding device properties from the device description database; and serving by the first system the cascading style sheet to the requesting device. Optionally, the requesting device is a browser equipped feature phone and the first system is configured to exclude or delete from the cascading style sheet directives not supported by the feature phone browser. In certain instances, the requesting device does not support CSS level 3, and the first system is configured to exclude or delete from the cascading style sheet CSS level 3 directives not supported by the requesting device. Optionally, the requesting device does not support media queries. Optionally the cookie generation code is included at a beginning of the first requested content.

An example aspect of the disclosure comprises a system comprising: a data store configured to at least store computer-executable instructions; and a hardware processor in communication with the data store, the hardware processor configured to execute the computer-executable instructions to at least: receive a first request for content from a browser of a requesting device; receive a user agent from the requesting device, the user agent comprising text identifying the browser type; serve cookie generation code to the requesting device, wherein the cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent; receive the device cookie from the requesting device; access a device description database, the device description database comprising device properties for a plurality of browser-equipped devices; utilize information from the user agent from the requesting device to locate corresponding device properties from the device description database; generate a cascading style sheet based at least in part on properties stored in the device cookie, including at least the display size, and the located corresponding device properties from the device description database; and serve the cascading style sheet to the requesting device.

An example aspect of the disclosure comprises a non-transitory computer-readable storage medium storing computer executable instructions that when executed by a processor perform operations comprising: receiving a first request for content from a browser of a requesting device; receiving a user agent from the requesting device, the user agent comprising text identifying the browser type; providing cookie generation code, wherein the cookie generation code is configured to be executed by the browser of the requesting device to obtain properties of the requesting device from the requesting device, including at least a display size in terms of pixels, and to store the obtained properties locally as a device cookie on the requesting device; receiving the device cookie from the requesting device; accessing a device description database, the device description database comprising device properties for a plurality of browser-equipped devices; utilizing information from the user agent from the requesting device to locate corresponding device properties from the device description database; generating a cascading style sheet based at least in part on properties stored in the device cookie, including at least the display size, and the located corresponding device properties from the device description database; and providing the cascading style sheet to the requesting device.

An example aspect of the disclosure comprises a non-transitory computer-readable storage medium storing computer executable instructions that when executed by a processor perform operations comprising: receiving a first request for content from a browser of a requesting device; providing cookie generation code, wherein the cookie generation code is configured to be executed by the browser of the requesting device to obtain properties of the requesting device from the requesting device, including at least a display size in terms of pixels, and to store the obtained properties locally as a device cookie on the requesting device; receiving the device cookie from the requesting device; generating a cascading style sheet based at least in part on properties stored in the device cookie, including at least the display size, and providing the cascading style sheet to the requesting device.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example architecture and process for creating Server-Side Media Query (SSMQ) Source Documents.

FIG. 2 illustrates an example architecture and process for generating a CSS file from a SSMQ Document.

FIG. 3 illustrates an example process for generating a customized formatting document.

### DETAILED DESCRIPTION

Systems and methods are described for generating documents, such as Server-Side Media Query (SSMQ) Source Documents, and for generating a corresponding formatting document, such as a Cascading Stylesheet (CSS).

The example systems and methods described herein optionally add support for certain properties, such as Media Query properties, to unsupported applications, such as web browsers that do not support such Media Query properties. Further, the example systems and methods described herein optionally reduce the size of files, such as CSS files, being downloaded to a user device, such as a mobile phone or other browser-equipped device, by excluding unsupported properties, rules and instructions (even though those properties, rules and instructions may be supported by smart phones and other relatively more powerful browser equipped devices). Thus, technologies disclosed herein optionally overcome the technical challenges presented by devices that do not adequately support property discovery technologies.

By way of illustration, certain phones may only support lower levels of CSS and/or only portions of CSS levels (e.g., a user device may support CSS level 1 and CSS level 2, but not CSS level 3). For example, a device that supports CSS 1 but not CSS 2 or CSS 3 may not support paged media (e.g., slide shows), aural style sheets, table elements, fixed positioning, etc. CSS 3 provides still additional features not available using CSS 2 or CSS 1, such as shadows, gradients, support on backgrounds for any type of <image> rounded corners, transitions or animations, multi-column layout, flexible box or grid layouts, etc. Thus, in order to reduce the CSS file size, a given CSS document may optionally be configured to exclude some or all CSS directives (e.g., background images on buttons) not supported by the target user device browser. By way of further example, some features phone may not fully support HTML4, HTML5, or future versions of HTML. Thus, systems and methods are described for customizing Cascading Stylesheet type documents based at least in part on the characteristics of the accessing device.

As well be described in greater detail herein, a platform may be provided for creating custom CSS files to be transmitted over a network to a user device, using a description of the device's physical and/or software characteristics and abilities (e.g., using information not provided by the user device's user agent, which is a character string typically identifying the client software). Certain of such characteristics and abilities may be retrieved from a data store remote from the device and/or determined from a device cookie describing properties of the device not found in the database. Optional examples of such characteristics include the level of CSS supported, what features in a given level of CSS are supported (e.g., whether the device supports proportional fonts, whether the device browser displays tables correctly, whether the browser supports line wrapping, whether images may be used to represent links, etc.), the user device display size (in terms of pixels and/or physical dimensions such as inches), the pixel density, the user display orientation, the user device's pointing method (e.g., touch screen, joystick, click wheel, stylus, etc.), other hardware characteristics (e.g., such as an indication as to whether the device includes a QWERTY keyboard), what aspects of different versions of HTML are supported, the specific model of the user device, etc.

The platform may comprise a web server hosting a program, also referred to as a SSMQ compiler. Optionally, the SSMQ complier enables a web developer to code an SSMQ source document so as to reduce the file size of the CSS file downloaded to the requesting device by excluding unsupported properties, rules, and instructions, and to customize the rendered webpage with little programming effort.

An overview of SSMQs, CSS, and Media Queries will now be provided.

A Server-side Media Query (SSMQ) describes a method and syntax for programmatically compiling Cascading Style Sheets (CSS) on a web server based at least in part on known and/or detected properties of a remote device (e.g., a client device, such as a mobile phone, personal digital assistant, tablet, laptop, netbook, desktop, television, etc.) on which a corresponding webpage is to be rendered. By way of background, a CSS employs a property-based syntax used by applications which can render webpages, such as a web browser, to describe the visual layout of documents, such as HTML documents. CSS files are downloaded by browsers and interpreted in a structured manner. The properties described by the CSS files are applied to the HTML document as the HTML document is rendered visually on a device (e.g., a client device, such as a mobile phone, personal digital assistant, tablet, laptop, netbook, desktop, television, etc.). A given CSS property may target a specific aspect of the visual layout, such as, by way of non-comprehensive, example, color, size, font, margins, dimensions, padding, tables, decoration (e.g., borders, background images) or screen position.

By way of further background, typically, a CSS document is created and transmitted in plain text from a web server, over a network (e.g., the Internet) to a browser hosted on a client device, where the CSS document is interpreted. CSS files are rarely served alone; they are generally specified as part of an HTML (or HTML-like) document and requested alongside other document assets such as images, fonts, or script source files. The receiving browser will then render the HTML document according to the properties and rules specified in the CSS file(s).

The CSS specification is implemented in compliant browsers so that they can process CSS files, but the results of processing a CSS file can vary widely from browser to browser, depending on the age of the browser and the choices made by the browser manufacturer. As similarly noted elsewhere herein, many older and low powered devices, such as feature phones (basic, low end phones having few or no features beyond being able to place and receive calls and text messaging)) or early smartphones, do not implement the CSS specification at all or only implement one or more CSS levels incompletely (e.g., do not implement all CSS levels or only implement portions of a given CSS level), and sometimes such devices ignore certain properties that they are unable or unwilling to render.

Media Queries provide a method for applying CSS properties appropriately for specific conditions, such as the width of the browser's screen. In this manner, a CSS author can describe different layouts more appropriate to the specific rendering environment. The Media Query syntax is a fairly recent innovation and is rarely supported on older devices. A CSS file author is limited to querying the properties supported by the browser maker. In practice, this list is short and does not cover many areas useful for web developers. Hence, conventionally only very limited rendering environment information can be obtained from many devices using Media Queries.

By way of illustration, an example conventional media query is provided below:

```
@media (min-width: 768px) and (max-width: 979px) {
      /* CSS styles which apply to a browser whose
      window width is >= 768 pixels but <= 979px */
}
```

An Example Implementation of a Server-Side Media Query Solution

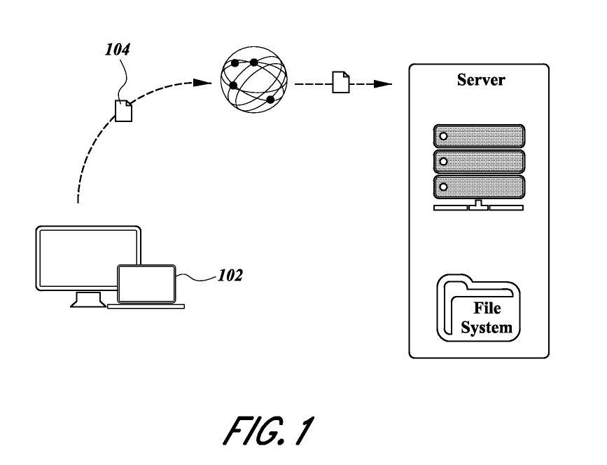

Because CSS documents are served as plain text, they can be written statically by an author using the example platform (see, e.g., the example system illustrated in FIG. 1), transmitted via a network, received by a server, and stored by the server in a data store (e.g., a file system) to be made available to requesting devices (e.g., devices hosting a browser), such as via a globally unique locator (such as a URL). However, a CSS document can also be created by a program which can generate a text document in the correct format, and the program can serve different versions of the CSS document to different requesting browsers, despite all versions sharing an identical URL, where the different requesting browsers' requests are all for the identical URL.

When requesting a document from a web server, web browsers typically provide an additional identification string known as a user agent. The user agent conventionally includes a character string identifying the client software and its version number, and optionally the associated client software platform (e.g., mobile device model identifier, such as “iPad”, without specifying the specific model/version, such as “iPad Air”), platform details (e.g., the operating system being used, such as “iOS”), and platform extensions (e.g., layout engine)), and may optionally include a brief description of similar applications with which the client software is compatible.

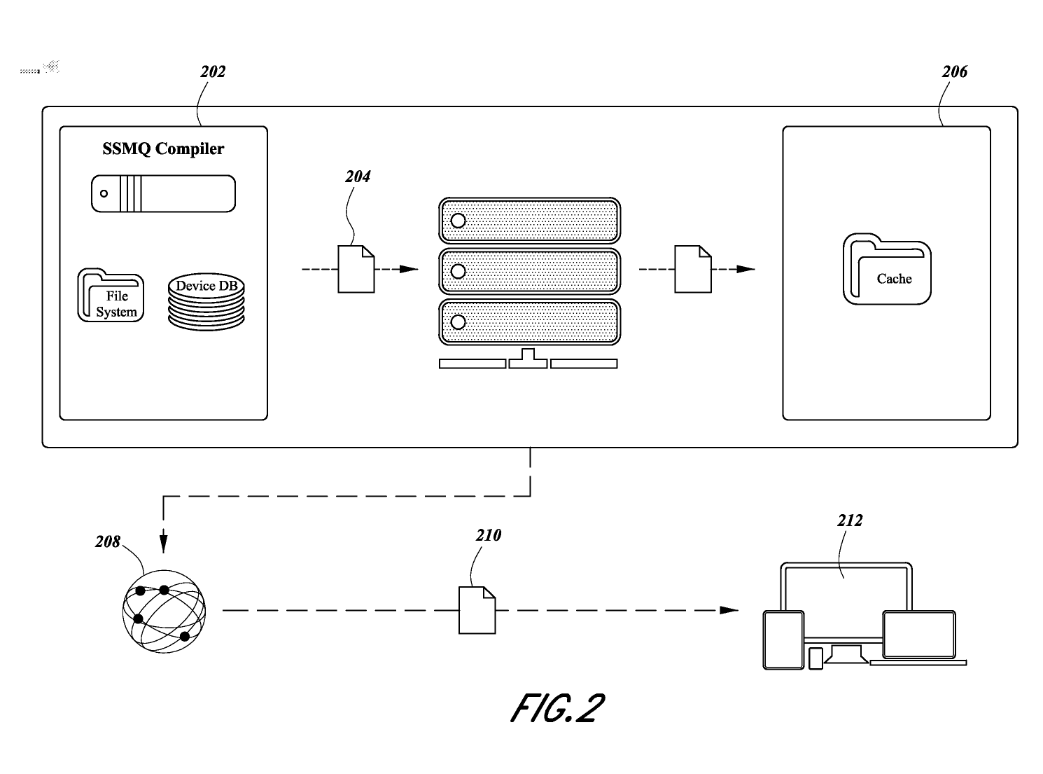

However, disadvantageously, the user agent typically does not fully or adequately describe the hardware characteristics of the accessing device. For example, a user agent string conventionally does not include screen size information (e.g., in terms of either pixels of physical screen size) or pixel density of the accessing device. In order to overcome this limitation, an example system disclosed herein (see, e.g., FIG. 2) optionally accesses a data store of known user agent strings and maps such user agent strings to hardware characteristics of those devices, wherein the hardware characteristics may include more hardware information than would be provided by the device itself in response to a media query. The example system then compiles a customized CSS file using such device hardware information for the requesting device.

Another disadvantage of conventional user agents is that they are not descriptive enough to differentiate between similar products from the same manufacturer (e.g., where products in a given product line may have different display characteristics, browser versions, etc.). In addition, the information provided by a given user agent may not accurately reflect the characteristics of the user device and/or the version of the user device or its hardware and/or software components. For example, a given device manufacturer may configure devices having different characteristics to provide the same user agent. Optionally, the example system described herein utilizes a technology, sometimes referred to herein as a “device cookie”, which may be used to provide information on such device properties missing from conventional user agents and/or which better identify the specific model/version of the user device (e.g., wherein such information is sufficient to distinguish between different products and models of products from the same manufacturer).

A conventional “cookie” is a standard technology implemented by web browsers which allows for storage of small snippets of text information. The browser often provides these cookies on every request to the web server. In contrast to conventional cookies, a device cookie as disclosed herein is created by the browser using a program provided by an example platform (e.g., comprising a web server) optionally after the user browser makes an initial request from the platform during a given session (e.g. for a webpage using a URL) and before the browser makes further requests (e.g., further URL requests) to the platform. The device cookie may contain such information which may be used to customize a webpage CSS document for webpage rendering, such as the device's screen orientation and screen resolution or CSS level support, wherein such is information is not conventionally made available to a web server. The device cookie may include a specific model identifier of the user device (e.g., IPHONE 5S®, rather than just a high level model identifier, such as IPHONE®) and/or detailed hardware/software properties of the user device (e.g., the level of CSS supported, what features in a given level of CSS are supported (e.g., whether the device supports proportional fonts, whether the device browser displays tables correctly, whether the browser supports line wrapping, whether images may be used to represent links, etc.), the user device display size (in terms of pixels and/or physical dimensions such as inches), the user display orientation, the user device's pointing method (e.g., touch screen, joystick, click wheel, stylus, etc.), other hardware characteristics, what aspects of different versions of HTML are supported, etc.).

Optionally, the device cookie is created by the requesting browser using a supported programming language (e.g., an interpreted runtime language, such as JavaScript). The browser makes certain properties available to the browser program, and other features can be derived by combining the properties. For example, if the exact screen size and browser window size are provided, the screen orientation can be determined by comparing the width and height of the window, where a device screen in landscape orientation is wider than it is tall. For example, certain properties are made available as part of the standard JavaScript DOM (document object model) (e.g., using a window.screen object) or an extension to that standard provided by the browser manufacturer. For example, JavaScript DOM may be used to obtain the following properties:

| Properties | Description |
|---|---|
| availHeight | Specifies the height of the screen, in pixels, |
| | minus interface features, such as a taskbar |
| availWidth | Specifies the width of the screen, in pixels, |
| | minus interface features, such as a taskbar |
| colorDepth | The bit depth of the color palette available |
| | for displaying images in bits per pixel |
| height | The total height of the screen, in pixels |
| pixelDepth | Display screen color resolution (bits per pixel) |
| width | The total width of the screen, in pixels. |

Optionally, by combining these items of information, including the device description information received from the accessing device via the user agent and the device hardware properties received via the device cookie, with the Media Query syntax via a program capable of creating CSS documents, the example platform generates CSS documents that are customized for the accessing device and its associated properties. For example, the generated CSS documents are optionally generated so that they do not contain any extraneous browser directives or properties that the device browser will not understand and optionally ensure that documents, such as webpages, served to the user device are of the appropriate size for the user device display. For example, the program may determine which directives a device browser may or may not understand, exclude or delete from the CSS document those directives that the device browser does not understand and does not support. The CSS document may then be transmitted over a network, such as the Internet, to the accessing device.

Optionally, certain embodiments combine SSMQ with LESS or other CSS pre-processor that extends the CSS language, adding features, such as those that allow variables, mixins, functions and/or other features that facilitate making CSS that maintainable, themable and extendable.

An illustrative example is as follows, where the CSS property is to only be applied to a device having a screen width greater or equal than 320 logical pixels:

```
@media (-mb-min-device-width: 320px) {
      /* CSS properties which apply to a device whose
      screen is >= 320 logical pixels */
      h1 {
      color: blue;
      }
}
```

In the example above, when the platform determines via a device cookie and/or the device description database that the user device making a webpage request is a phone whose logical screen width is exactly 320 pixels, the generated document would contain:

h1 {
color: blue;
}

However, when requested by a device whose screen width is only 160 pixels, the document would be empty. Thus, the web developer or other entity may code a program, such as may be embodied in an SSMQ source document, that can be complied by a complier in accordance with a user's device properties so as to exclude directives that the developer or other entity has indicated are not applicable for a device having such properties.

The following is a non-exclusive list of example phone properties which may be optionally be queried using SSMQs and which are not normally available to web developers (or which may be provided by a user agent, but wherein the user agent data is not reliable) and so normally are not used in providing customized webpages and other documents to a requesting device:

Device operating system name and version

Pointing method (mouse, touch, stylus)

Device manufacturer name

Type (tablet, phone, desktop computer, laptop, console, TV)

Browser brand name and rendering technology

Maximum supported image dimensions

Support for image display types (JPG, PNG, SVG, etc.)

As similarly noted above, Media Queries are normally parsed by the browser, and therefore the MQs available to a web developer or other entity, and to the server serving the CSS are limited to those exposed by the browser maker. In addition, the MQ syntax is fairly new and there are often incompatibilities between the implementations. As also noted above, conventionally, an inefficiency of Media Queries is that the entire document is transmitted to the browser, even though parts (e.g. certain browser directives) of the document may be ignored entirely because the browser has not been configured to process such parts. SSMQs, as disclosed herein, optionally reduce the total size of the document sent to the device by enabling the elimination of such parts, which is beneficial in low- or limited-bandwidth scenarios such as devices connected to a cellular network, or in developing countries with limited infrastructure.

As noted above, feature phones are a category of underpowered, low-function, mobile devices, usually of older design or sold at a lower price than a smartphone, which contains far more computing power and a more powerful operating system than a feature phone. Features phones may still be configured to access to the Internet, and generally include an embedded Web browser with limited functionality. Often these limited functionality web browsers implement a subset of the CSS specification, and have limited or no scripting support.

To support such feature phones and their limited functionality web browsers, the example platform optionally utilizes the device's user agent and/or a device cookie, and the database of known device types and their properties. When compiling a CSS file, such as for a feature phone, an example SSMQ compiler hosted by the web server strips out or excludes some or all CSS properties which do not correspond to the Media Queries specified by the web developer and that are not supported (e.g., were the browser will always return a “false” value as a response for such unsupported Media Queries, or will simply ignore or not execute such unsupported Media Queries) by the feature phone browser.

Because, in this example, the CSS is generated on a web server with access to a device description database, rather than being interpreted on a device's browser as is conventionally performed, the example platform can query for properties which are not widely supported by browser manufacturers. For example, a traditional MQ would allow the web developer to cause a server to query the width of the browser window, but not the physical size of the device's screen. By contrast, the example platform enables such physical property data to be obtained via the device description database. Additionally, the example platform optionally enables web developers to write media queries for devices and device browsers that do not support Media Queries in any capacity.

To comply with the CSS specification, the example platform optionally adds text (e.g., a ‘-mb’ prefix) to some or all properties which are supported only by the example platform's SSMQ implementation. This is to indicate that these properties are non-standard and are not formally recognized as part of the specification. If a document containing these SSMQ properties were served to a web browser, they would simply be ignored and would not trigger errors.

Certain features and technologies will now be discussed with reference to the figures.

Referring to FIG. 1, an example architecture and process for creating Server-Side Media Query (SSMQ) Source Documents are illustrated.

At state 102, one or more documents, such as Server-Side Media Query (SSMQ) source documents, are created via an application remote from a target device. For example, the application may be a web browser of a website administrator or other user. Once the SSMQ source documents are generated, at state 104 they are transmitted by the application (e.g., the browser) over a network (e.g., the Internet) to a web server. The web server may be operated by an entity different than the entity generating the SSMQ source documents. For example, the entity generating the SSMQ source documents may be a customer of a service provided by the operating of the server, such as a website building and/or hosting service. Optionally instead, the SSMQ source documents are generated on the server. At state 106, the web server stores the SSMQ document in a file system.

Referring now to FIG. 2, an example architecture and process for generating a CSS file from a SSMQ Document are illustrated. At state 202, an accessing device, such as a client mobile device or other device type, transmits a request (e.g., for content, such as a webpage using an URL), the request including a user agent and/or a device cookie. The user agent may optionally be provided via an HTTP user-agent header field. The user agent conventionally includes a character string identifying the client software and its version number, and optionally the associated client software platform (e.g., mobile device model identifier, such as “iPad”), platform details (e.g., the operating system being used, such as “iOS”), and platform extensions (e.g., layout engine)), and may optionally include a brief description of similar applications with which the client software is compatible. Disadvantageously, a user agent string conventionally does not provide or describe details of hardware properties of the accessing device, such as screen size (neither in pixels nor the physical screen size) or pixel density. In addition, as noted elsewhere herein, the user agent may not be accurate.

At state 204, the server receives the request. The server may include or be configured to remotely access a data store of device characteristics (sometimes referred to as a device description data store). For example, the device description data store may indicate rendering information of the device (e.g., the device's screen orientation (e.g., landscape or portrait), the screen's dimensions in pixels, etc.), the brand name, model name, model version, an indication as to the device type (e.g., phone, tablet, etc.), pointing method (e.g., touch screen, joystick, click wheel, stylus), an indication as to whether the device includes a QWERTY keyboard, the CSS level supported, the degree a given CSS level is supported (e.g., whether the device supports proportional fonts, whether the device browser displays tables correctly, whether the browser supports line wrapping, whether images may be used to represent links), what aspects of different versions of HTML are supported, etc.

A complier (e.g., an SSMQ compiler) hosted on the server utilizes user agent and/or a device cookie information (e.g., a device model name or other identifier) to locate characteristics of the accessing device stored in the device description data store.

At state 206, the compiler uses the device characteristics from the device description data store and/or from the device cookie, as well as the SSMQ source document, to generate a CSS file customized for that device, optionally without directives that would not be understood and/or executed by the requesting device's browser.

At state 208, the web server transmits the customized CSS document over the network. At state 210, the receiving device receives the customized CSS document. At state 212, the client device applies the customized CSS document and renders the corresponding webpage.

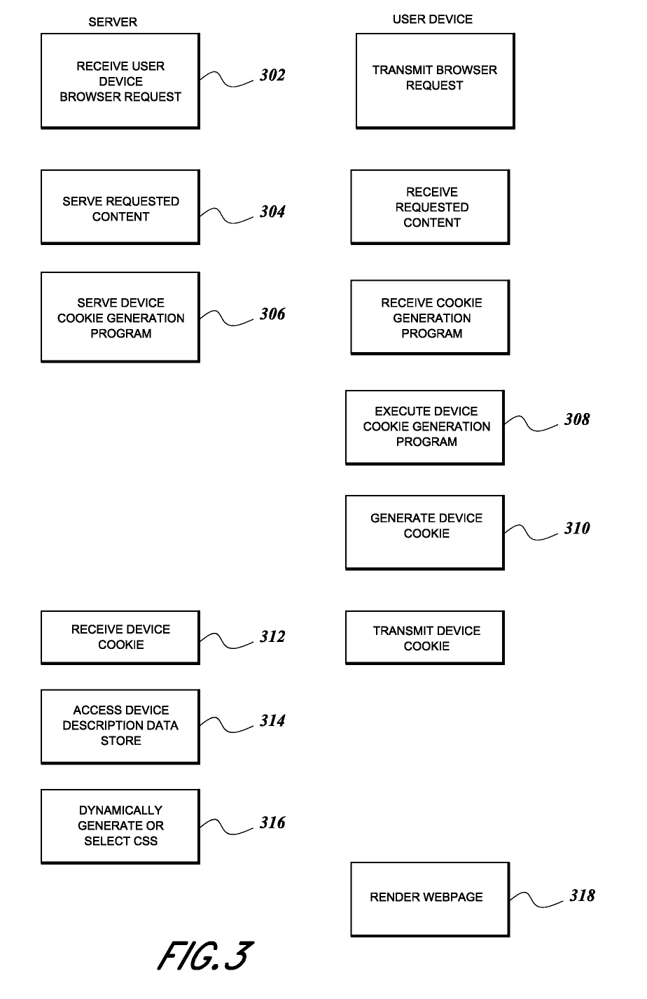

FIG. 3 illustrates an optional process for creating and utilizing a device cookie. At block 302, a request is received at the platform from a user device. For example, the request may include a URL received from a user device browser. A user agent, providing limited information regarding the user device, may also be received from the user device browser. Optionally, at block 304, the platform, via a web server, serves the requested content using a first, pre-generated CSS. Thus, optionally the first CSS is not customized or not appropriately customized for the requesting user device. For example, the content served to the user device may be larger than the user device display, and so the user device will need to scale the content to fit on the user device display. For example, even if the user device display is only 320×480 pixels, the CSS and webpage may be configured for a 640×1136 pixel display. Optionally, the limited information available from the user agent may be used in determining the initial CSS document provided to the user browser.

At block 306 (which may occur before, at substantially the same time, or after the content is served), a device cookie generation program (e.g., configured to be interpreted and executed by the user device browser) is provided to the user browser by the platform. Optionally, the device cookie generation program code is placed at the very beginning of the non-customized document to speed up the initiation of the browser process of generating the device cookie which may be used by the platform to customize future documents.

At block 308, the user device browser interprets and executes the device cookie generation program. At block 310, the device cookie generation program accesses user device hardware and/or software information from the user device and generates a device cookie storing some or all of the accessed device hardware and/or software information. For example, the generated device cookie may optionally only include a specific model identifier (which may include a manufacturer identifier, a model identifier, and/or a model version identifier), only hardware and/or software information (e.g., some or all of the example information discussed herein, such as display size information, and/or different hardware and/or software information) without including the specific model identifier, or may include both the model identifier and the hardware and/or software information.

At block 312, the platform receives the device cookie. At block 314, the platform optionally uses the user agent and/or the device cookie to locate and access user device characteristics from a device description data store. At block 316, the platform dynamically generates (e.g., using a compiler) or selects a CSS document customized for characteristics of the user device based at least in part on the device cookie hardware and/or software information and/or characteristics from the device description data store. The CSS document may optionally be generated based in part on the user agent. At block 318, the user device browser may use the customized CSS document to render the requested content. Optionally, the platform may serve one or more subsequent webpages to the user device using the information obtained at blocks 312 and/or 314.

All of the methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The results of the disclosed methods may be stored in any type of computer data repository, such as relational databases and flat file systems that use magnetic disk storage and/or solid state RAM.

While the phrase “click” may be used with respect to a user selecting a control or the like, other user inputs may be used, such as voice commands, text entry, gestures, etc.

Many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer-implemented method of customizing a cascading style sheet for a requesting device, the method comprising:
receiving at a server a first request for content from a browser of a requesting device, wherein the requesting device does not support or is not configured to execute at least one media query property;
receiving at the server a user agent from the requesting device, the user agent comprising text identifying the browser type;
serving the first requested content and device cookie generation code to the requesting device, wherein the device cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent;
receiving at the server the device cookie from the requesting device;
accessing by the server a device description database, the device description database comprising device properties for a plurality of browser-equipped devices;
utilizing information from the user agent from the requesting device to locate corresponding device properties from the device description database;
compiling, by the server using a server side media query compiler, a cascading style sheet based at least in part on properties stored in the device cookie, including at least the display size, and the located corresponding device properties from the device description database, wherein the compiler is configured to exclude, based on the properties stored in the device cookie and the located corresponding device properties, one or more browser CSS properties that are not supported or that will not be executed by the browser of the requesting device; and
serving by the first system the cascading style sheet to the requesting device.

2. The method as defined in claim 1, wherein the requesting device is a feature phone and the server side media query compiler is configured to exclude or delete from the cascading style sheet directives not executable by the feature phone browser.

3. The method as defined in claim 1, wherein the requesting device does not support CSS level 3, and the server side media query compiler is configured to exclude or delete from the cascading style sheet CSS level 3 directives not executable by the requesting device.

4. The method as defined in claim 1, wherein the device cookie generation code is included at a beginning of the first requested content.

5. The method as defined in claim 1, wherein the requesting device does not support media queries.

6. The method as defined in claim 1, wherein the device cookie identifies one or more device properties not provided by the user agent or the device description database.

7. A computer-implemented method of customizing a cascading style sheet for a requesting device, the method comprising:
receiving at a first system a first request for content from a browser of a requesting device, the first system comprising hardware;
receiving at the first system a user agent from the requesting device, the user agent comprising text identifying the browser type;
serving cookie generation code to the requesting device, wherein the cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent;
receiving at the first system the device cookie from the requesting device;
accessing by the first system a device description database, the device description database comprising device properties for a plurality of browser-equipped devices;
utilizing information from the user agent from the requesting device to locate corresponding device properties from the device description database;
compiling, by the first system a cascading style sheet based at least in part on properties stored in the device cookie, including at least the display size, and the located corresponding device properties from the device description database; and
serving by the first system the cascading style sheet to the requesting device.

8. The method as defined in claim 7, wherein the requesting device is a feature phone and the first system is configured to exclude or delete from the cascading style sheet directives not supported by the feature phone browser.

9. The method as defined in claim 7, wherein the requesting device does not support CSS level 3, and the first system is configured to exclude or delete from the cascading style sheet CSS level 3 directives not supported by the requesting device.

10. The method as defined in claim 7, wherein the requesting device does not support media queries.

11. The method as defined in claim 7, wherein the cookie generation code is included at a beginning of the first requested content.

12. A system comprising:
a data store configured to at least store computer-executable instructions; and
a hardware processor in communication with the data store, the hardware processor configured to execute the computer-executable instructions to at least:
receive a first request for content from a browser of a requesting device;
receive a user agent from the requesting device, the user agent comprising text identifying the browser type;
serve cookie generation code to the requesting device, wherein the cookie generation code is configured to be executed by the browser of the requesting device to obtain properties of the requesting device from the requesting device, including at least a display size in terms of pixels, and to store the obtained properties locally as a device cookie on the requesting device, the properties including at least one device property not available from the requesting device via a media query or a user agent;
receive the device cookie from the requesting device;
access a device description database, the device description database comprising device properties for a plurality of browser-equipped devices;
utilize information from the user agent from the requesting device to locate corresponding device properties from the device description database;
generate a cascading style sheet based at least in part on properties stored in the device cookie, including at least the display size, and the located corresponding device properties from the device description database; and
serve the cascading style sheet to the requesting device.

13. The system as defined in claim 12, wherein the requesting device is a feature phone and the system is configured to exclude or delete from the cascading style sheet directives not supported by the feature phone browser.

14. The system as defined in claim 12, wherein the requesting device does not support CSS level 3, and the system is configured to exclude or delete from the cascading style sheet CSS level 3 directives not supported by the requesting device.

15. The system as defined in claim 12, wherein the requesting device does not support media queries.

16. The system as defined in claim 12, wherein the cookie generation code is included at a beginning of the first requested content.

17. A non-transitory computer-readable storage medium storing computer-executable instructions that when executed by a processor perform operations comprising:
receiving a first request for content from a browser of a requesting device;
receiving a user agent from the requesting device, the user agent comprising text identifying the browser type;
providing cookie generation code, wherein the cookie generation code is configured to be executed by the browser of the requesting device to obtain properties of the requesting device from the requesting device, including at least a display size in terms of pixels, and to store the obtained properties locally as a device cookie on the requesting device;
receiving the device cookie from the requesting device;
accessing a device description database, the device description database comprising device properties for a plurality of browser-equipped devices;
utilizing information from the user agent from the requesting device to locate corresponding device properties from the device description database;
generating a cascading style sheet based at least in part on properties stored in the device cookie, including at least the display size, and the located corresponding device properties from the device description database; and
providing the cascading style sheet to the requesting device.

18. The non-transitory computer-readable storage medium as defined in claim 17, wherein the requesting device is a feature phone and the operations are configured to exclude or delete from the cascading style sheet directives not supported by the feature phone browser.

19. The non-transitory computer-readable storage medium as defined in claim 17, wherein the requesting device does not support CSS level 3, and the operations are configured to exclude or delete from the cascading style sheet CSS level 3 directives not supported by the requesting device.

20. The non-transitory computer-readable storage medium as defined in claim 17, wherein the requesting device does not support media queries.

21. The non-transitory computer-readable storage medium as defined in claim 17, wherein the cookie generation code is included at a beginning of the first requested content.
